(19) United States
(12) Patent Application Publication
(10) Pub. No.: US 2008/0204528 A1
(43) Pub. Date: Aug. 28, 2008

(54) INK CARTRIDGE

(76) Inventor: Kenneth Yuen, San Gabriel, CA (US)

Correspondence Address: MERCHANT & GOULD PC, P.O. BOX 2903, MINNEAPOLIS, MN, 55402-0903, US

(21) Appl. No.: 11/680,458

(22) Filed: Feb. 28, 2007

(51) Int. Cl. B41J 2/175

(52) U.S. Cl. 347/86

(57) ABSTRACT

An ink cartridge including a housing, an ink outlet arrangement, an air vent arrangement, and at least one handle. The housing includes at least a top wall, a bottom wall, and a plurality of side walls that define an ink reservoir. The ink outlet is positioned at the bottom wall. The air vent arrangement includes an air inlet to the ink reservoir that is positioned adjacent to the bottom wall. The handles extend from opposing sides of the housing. The handles each include a pliable portion. The pliable portion is arranged spaced apart from the side wall of the housing from which the handles extend. The ink cartridge can further include an extension member that extends from the bottom housing at the bottom wall. An extension member is configured to mount an electronic chip.

### TECHNICAL FIELD

The present invention generally relates to ink containers, and more particularly relates to ink cartridges for use with ink jet printers.

### BACKGROUND

Ink jet printers are a popular form of printer used with computers and similar applications involving document printing or graphics preparation. Typical ink jet printers have replaceable ink cartridges. A common issue in many ink cartridges is the tendency for ink to drip out of the ink outlet when the ink cartridge is not mounted in the ink jet printer. One solution for this problem is to add an ink absorbing material such as a foam product inside the ink chamber. The foam reduces ink pressure at the ink outlet thereby reducing incidence of undesired dripping ink. A related issue is the tendency for ink to overflow out of the ink outlet junction with the ink jet printer or out of the print head of the printer when the ink cartridge is mounted to the printer. The overflow of ink at the junction or the print head typically results from uncontrolled or excessive ink flow out of the ink outlet. The overflowing ink can damage the printer or components of the ink cartridge, such as an electronics chip mounted on the ink cartridge. Providing reliable control of ink flow from the ink cartridge and related air flow into the ink reservoir of the ink cartridge are important aspects of an ink cartridge design.

A further issue related to mounting the ink cartridge to a printer. Some printers include ink cartridge bays or carriages that are configured to hold the ink cartridge. Improved configurations for releasably retaining ink cartridges in a printer would be an advance in the art.

### SUMMARY

The present disclosure relates to an ink cartridge for use in an ink jet type printer. The ink cartridge includes a housing, an ink outlet arrangement, and an air vent arrangement. The ink cartridge can also include at least one handle, an extension member, and an electronics chip. The housing includes at least a top wall, a bottom wall, and a plurality of side walls that define an ink reservoir. The ink outlet is positioned at the bottom wall and provide an outlet for removal of ink from the ink reservoir. The air vent arrangement includes an air inlet to the ink reservoir that is positioned adjacent to the bottom wall. The air vent arrangement provides a minimum negative pressure condition in the ink reservoir that help reduce undesired dripping of ink from the ink cartridge. The handles extend from opposing sides of the housing. The handles can include a pliable portion that helps maintain the ink cartridge in the printer with an interference fit. The pliable portion is arranged spaced apart from the side wall of the housing from which the handles extend. The extension member is configured to mount the electronics chip.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that the invention/inventions of the disclosure are not limited to such embodiments.

### BRIEF DESCRIPTION OF THE DRAWINGS

FIG. 1 is a schematic front perspective view of an example cartridge assembly in accordance with principle of the present disclosure.

FIG. 2 is a front view of the cartridge assembly shown in FIG. 1.

FIG. 3 is a rear view of the cartridge assembly shown in FIG. 1.

FIG. 4 is a right side view of the cartridge assembly shown in FIG. 1.

FIG. 5 is a left side view of the cartridge assembly shown in FIG. 1.

FIG. 6 is a top view of the cartridge assembly shown in FIG. 1.

FIG. 7 is a bottom view of the cartridge assembly shown in FIG. 1.

FIG. 8 is a exploded perspective view of the cartridge assembly shown in FIG. 1.

FIG. 9 is a cross-sectional view of the cartridge assembly shown in FIG. 4 taken along cross-sectional indicators 9-9.

FIG. 10 is front perspective view of the housing of the cartridge assembly shown in FIG. 1 with the cover removed.

FIG. 11 is a front view of the cartridge assembly housing shown in FIG. 10.

FIG. 12 is a cross-sectional view of the cartridge assembly housing shown in FIG. 11 taken along cross-sectional indicators 12-12.

FIG. 13 is a cross-sectional view of the cartridge assembly housing shown in FIG. 11 taken along cross sectional indicators 13-13.

While the inventive aspects of the present disclosure are amenable to various modifications and alternate forms, specific embodiments thereof have been shown by way of example in the drawings, and will be described in detail. It should be understood, however, that the intention is not to limit the inventive aspects to the particular embodiments described. On the contrary, the intention is to cover all modifications, equivalents, and alternatives falling within the spirit and scope of the inventive aspects.

### DETAILED DESCRIPTION

The present disclosure relates to replaceable ink containers that provide ink to an ink jet printer. The ink container, also referred to as an ink cartridge, includes a housing that defines an ink reservoir, an air vent arrangement in air flow communication with the ink reservoir, and an ink outlet arrangement in ink flow communication with ink reservoir. The air vent arrangement provides a one-way air inlet into the ink reservoir near a bottom internal surface of the ink reservoir. The ink outlet arrangement provides a one-way ink outlet from the ink reservoir. The housing includes at least one handle member that extends from a sidewall of the housing. The handle member provides an interference fit in a cartridge bay or cartridge carrier structure of a printer to which the ink cartridge is mounted. The interference fit helps hold the cartridge in a mounted orientation in the printer while permitting easy removal of the cartridge as needed by a user.

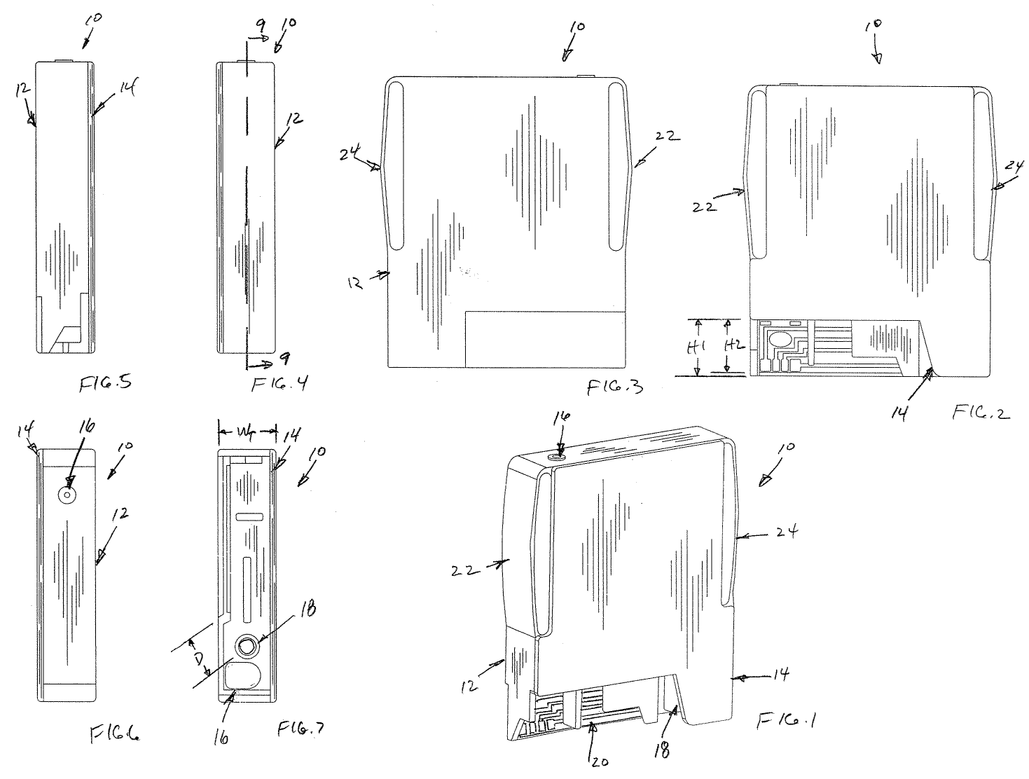

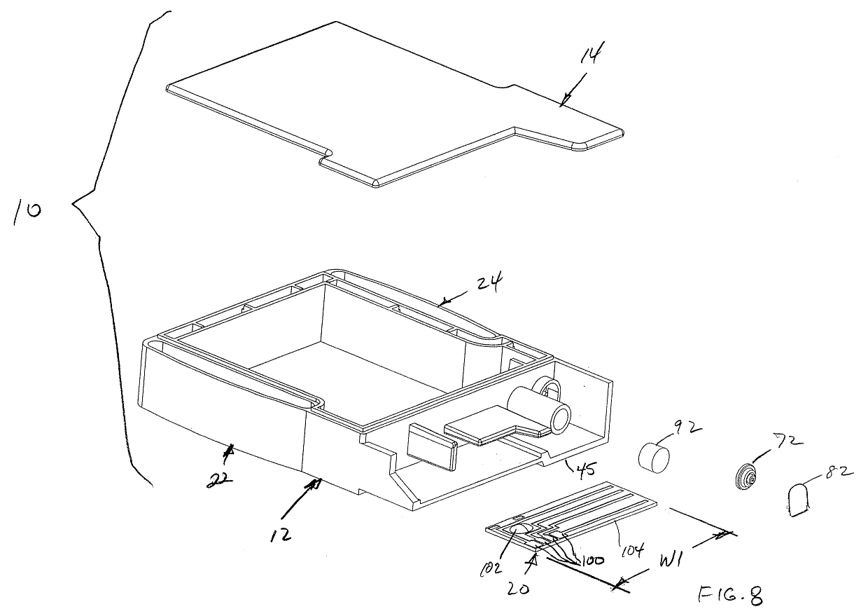

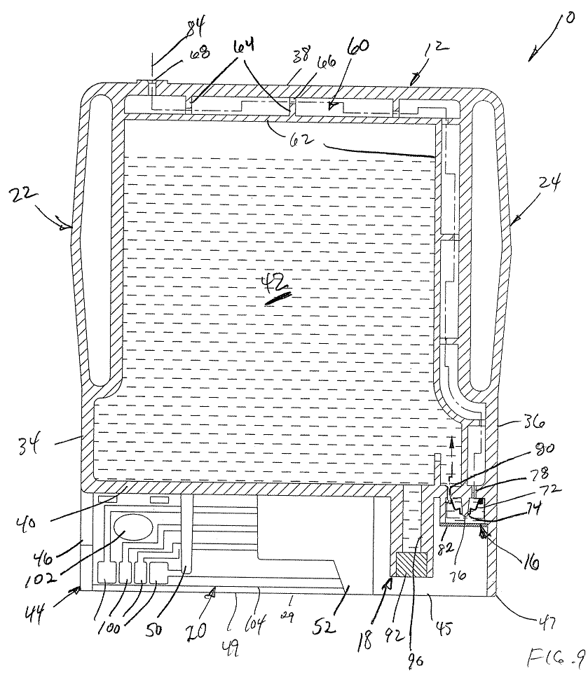

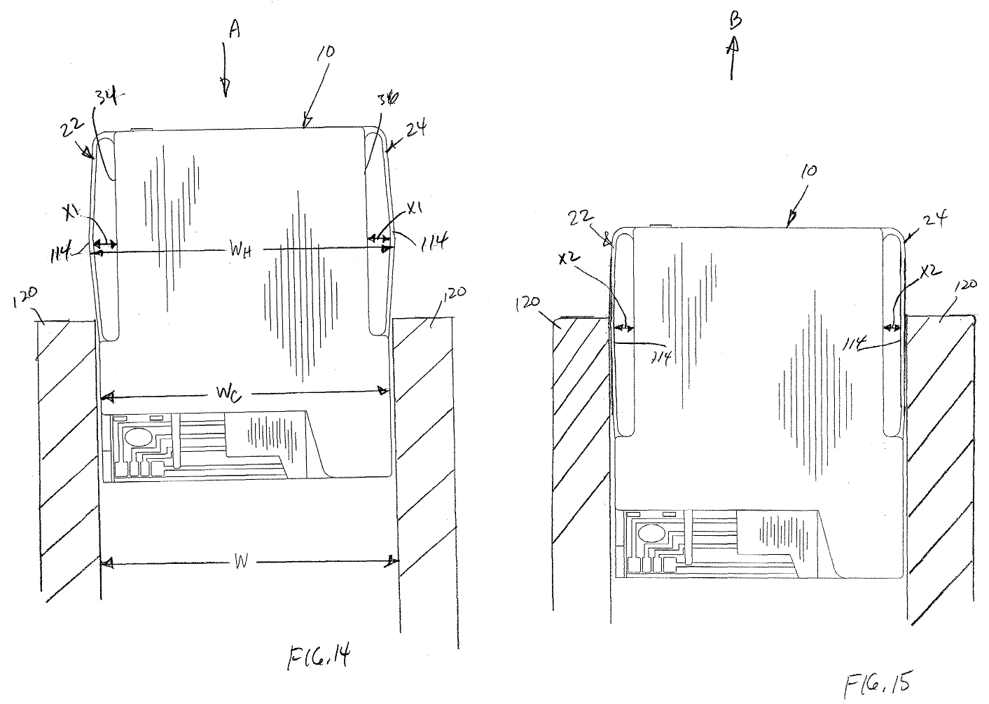

### Example of FIGS. 1-13

Referring now to FIGS. 1-9, an example cartridge assembly 10 is shown and described. The cartridge assembly 10 includes as housing 12, a front cover 14, an air vent arrangement 16, an ink outlet arrangement 18, an electronic chip 20, and first and second handles 22, 24. When assembled together, the components of the cartridge assembly 10 are arranged as a single unit that can be mounted to a printer to provide a supply of ink to the printer. The printer can include a cartridge bay or other type of cartridge carrier structure that retains the cartridge assembly 10. Cartridge assembly 10 includes several features that provide advantages such as, for example, ease of use for the user, prevention of unintentional drip or overflow of ink from the cartridge assembly, and ease of manufacturing and assembly of the cartridge assembly.

The housing 12 includes a front surface 30, a rear wall 32, first and second side walls 34, 36, and top and bottom walls 38, 40. When the front cover 14 is secured to the front surface 30, the front cover 14 along with the walls 32, 34, 36, 38, 40 together define an ink reservoir 42 to hold a volume of ink. In other configurations, the removable cover 14 can define a different portion or additional portions of the cartridge assembly, such as portions of the top, bottom rear, first or second walls of the housing.

The housing 12 further includes an extension member 44 that extends from the bottom wall 40 in a direction opposite the ink reservoir 42. The extension includes a rear portion 45, first and second side portions 46, 48, and a chip mounting surface 48 defined on the rear portion 45. The extension 44 is configured as a continuous wall structure. A thickness of the wall structure material is typically less than an overall width of the housing 12 defined between the front surface 30 and an exterior surface of the rear wall 32. The chip mounting surface 48 is sized and configured to receive the chip 20 mounted thereto. The chip mounting surface 48 can include a recess, protrusions, or other structure that facilitates mounting of the chip 20.

In other configurations, the extension 44 can be formed as a separate piece from the walls 30, 34, 36, 38, 40 of the housing 12, and secured in a separate assembly step in the arrangement shown in the Figures. Alternatively, the extension 44 can be formed with the walls 32, 34, 36, 38, 40 in a single molding step such as a co-molding or injection molding step. In general, the extension 44 is considered a separate feature from the housing 12. The extension 44 does not define an enclosure and does not form part or portion of the ink reservoir 42. When the chip 20 is mounted to the extension 44, the chip 20 is fully exposed to contact (e.g., contact by user's finger), to ink that may inadvertently escape of the out ink outlet 18, and to other contaminants or environments that may cause damage to the chip 20. The extension 44 does not define a recess or cavity within which the chip is positioned.

The housing 12 can further include first and second alignment members 50, 52 that are positioned on the bottom wall 40. The first alignment member 50 (see FIG. 9) can be used to help align a first set of features of the printer (e.g., electrical connector member) with features of the chip 20. The second alignment member 52 can be used to align a second set of features of the printer (e.g., an ink communication member) with the ink outlet arrangement 18. The alignment members 50, 52 are spaced from the extension 44 and extend free of contact from all of the structures of the cartridge assembly 10 except for the bottom wall 40. In other arrangements, the alignment members 50, 52 can engage the extension 44 or be formed as part of the extension 44.

The air vent arrangement 16 provides a source of air to the ink reservoir 42. The source of air replaces the volume of ink that is drawn from the ink reservoir 42 during use of the cartridge assembly 10 in a printer. The air vent arrangement 16 can be configured to help maintain a minimum negative pressure condition within the ink reservoir 42. Maintaining a minimum negative pressure condition within the ink reservoir 42 can be helpful for reducing incidents of unintentional dripping of ink from the ink outlet arrangement 18 prior to mounting the cartridge assembly 10 to a printer. The minimum negative pressure condition also reduces the incidents of excess ink outflow to the printer when the cartridge assembly 10 is mounted to a printer. Excessive ink outflow from the ink outlet arrangement 18 can result in undesired dripping of ink at the print head of the printer.

The air vent arrangement 16 includes a channel wall 62 that extends in parallel with portions of the top wall 38 and second side wall 36 of the housing 12. A space arranged between the channel wall 62 and the housing 12 defines an air channel 60. The air channel 60 is configured to hold a volume of air. A plurality of wall supports 64 extend between the channel wall 62 and the walls 36, 38 of the housing 12. The support walls 64 provide structural support for the channel wall 62 and also help further define an air flow path 84 (shown as a broken line in FIG. 9) through the air channel 60. Each of the wall supports 64 includes a support opening 66. The support opening on adjacent wall supports is positioned at different locations (e.g., at opposite ends of the wall support 64) adjacent to the channel wall 62 or the housing wall 36, 38. The offset arrangement of the support opening 66 helps reduce the flow of ink through the air channel 60 in the event that ink inadvertently enters the air channel 60.

The air vent arrangement 16 includes a channel air inlet 68 positioned along the top wall 38. A valve assembly 70 is positioned along the bottom wall 40 at an opposing end portion of the air channel 60. The air vent arrangement 16 is configured to permit air to flow into the air channel 60 via the channel air inlet 68, pass through the valve assembly 70, and enter into the ink reservoir 42. Typically, air is drawn through the air vent arrangement 16 into the ink reservoir 42 when a threshold negative pressure condition within the ink reservoir 42 is met or exceeded. As noted above, a minimum negative pressure condition is maintained in the ink reservoir 42 as a result of the air inlet to the ink reservoir. Additional negative pressure is generated in the ink reservoir 42 as ink is drawn out of the ink outlet arrangement 18. This additional negative pressure creates or exceeds the minimum negative pressure condition required to initiate air flow into the ink reservoir through the air vent arrangement 16.

The valve assembly 70 includes a diaphragm 72, having a diaphragm opening 74, a diaphragm post 76, a valve air inlet 78, a reservoir air inlet 80, and a sealing member 82. The diaphragm 72 and the diaphragm post 76 are positioned in a valve chamber 86 that is defined vertically below the bottom wall 40 of the housing 12. When the ceiling member 82 is secured to the bottom surface of the valve chamber 86, the valve chamber 86 can hold a volume of ink on an outer or bottom side of the diaphragm 82 via ink flow through the reservoir air inlet 80, while the inner, top side of the diaphragm 72 is in air flow communication with the air channel 60 via the air valve inlet 78. Positioning the diaphragm 72 in the valve chamber 86 and positioning the valve chamber 86 at a location outside of the ink reservoir 42 can provide easier access to the diaphragm. The position of the diaphragm 72 and valve chamber 86 can also improve ease of manufacturing and assembly of the cartridge assembly 10. In other arrangements, portions of the valve assembly 70 can be positioned internal of the housing 12, such as within the ink reservoir 42 or within a portion of the air channel 60.

The valve assembly 70 functions as a one-way air valve to provide a source of air at substantially atmospheric pressure into the ink reservoir 42 at a location near or at the bottom wall 40 of the housing 12. In a rest state, when the pressure condition in the ink reservoir 42 is below the threshold negative pressure level, the diaphragm 72 engages the diaphragm post 76 with the post 76 engaged within the diaphragm opening 74. As noted above, the inner, upper side of diaphragm 72 is exposed to atmospheric air conditions via the air channel 60 and channel air inlet 68. The outer, bottom side of the diaphragm 72 is exposed to the pressure conditions in the ink reservoir 42 via the reservoir air inlet 80. When the threshold pressure in the ink reservoir 42 is met or exceeded, the diaphragm 72 is drawn away from the post 76, thereby permitting air to flow through the diaphragm opening 74 and into the ink reservoir 42 via the reservoir air inlet 80. When the negative pressure condition in the ink reservoir 42 is reduced below the threshold pressure level, the diaphragm 72 returns to the rest position in engagement with the diaphragm post 76 to prevent ink from flowing into the air channel 60 and air flowing into the ink reservoir.

While the air channel 60 of cartridge assembly 10 is shown in the Figures positioned within the housing 12 and front cover 14 adjacent to the ink reservoir 42, other arrangements include positioning at least portions of the air channel 60 outside of the housing 12 and cover 14. In some arrangements, portions of the air channel 60 are spaced apart from the ink reservoir 42. Further, the valve assembly 70 can be positioned at other locations relative to the bottom wall 40 of the housing 12. For example, the valve assembly 70 can be position along one of the side walls 34, 36 vertically above the bottom wall 40, or along a portion of the extension 44 vertically below the bottom wall 40. Preferably, the reservoir air inlet 80 is positioned within about 0 to about 5 millimeters vertically above or below the bottom wall 40. Preferably, the reservoir air inlet 80 associated with the valve assembly 70 is positioned at or below a minimum ink level within the ink reservoir 42 regardless of the fill level of ink within the ink reservoir 42. Typically, the ink air inlet 80 is positioned relatively close to the bottom wall 40.

The ink outlet arrangement 18 includes an ink channel 90 and a plug 92 positioned in the ink channel 90. The ink channel 90 extends vertically downward from the bottom wall 40. In the arrangement shown in the Figures, an inlet from the ink reservoir 42 to the ink channel 90 is positioned flush with a bottom internal surface of the bottom wall 40 within the ink reservoir 42. In other arrangements, the inlet to the ink channel 90 is positioned vertically above or below the top surface of the bottom wall 40. The plug 92 is preferably a re-sealable plug. Alternatively, the plug 92 is configured as a wick member.

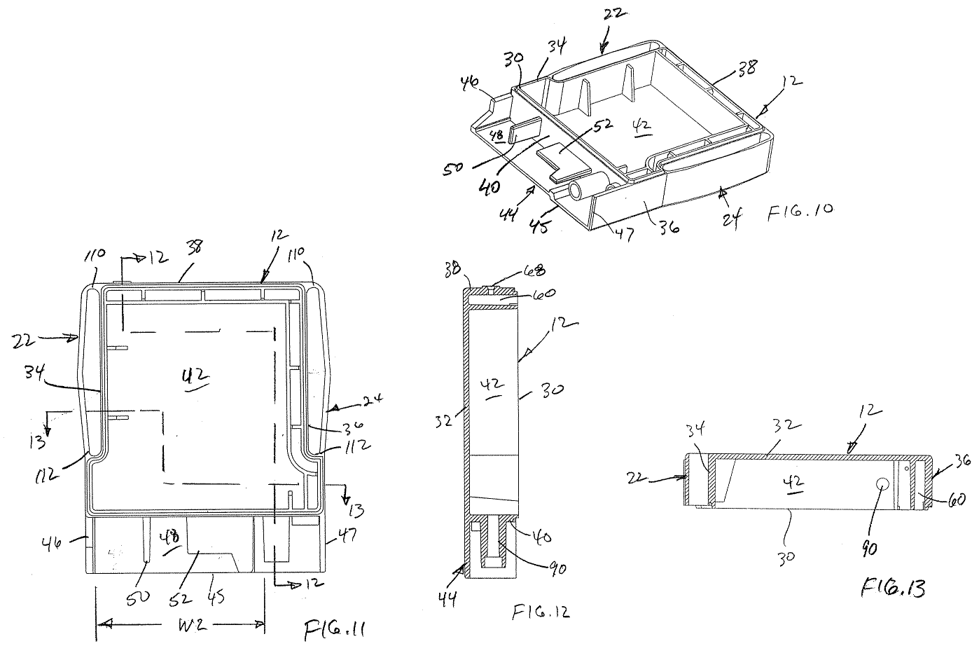

The chip 20 includes a plurality of electrical contacts 100, a memory or data storage portion 102, a bottom edge 104, and a width W1 (see FIG. 8). The chip 20 is positioned on the extension 44 such that the bottom edge 104 of the chip 20 is recessed away from a bottom edge 49 of the extension 44 (see FIG. 9). As a result, the electrical contacts 100 are not positioned at or along the bottom edge 49 of the extension 44.

Each of the electrical contacts 100 extends generally across the width W1 of the chip. Portions of the electrical contacts 100 are positioned close to the first side 46 of the extension 44 while other portions of each of the electrical contacts extend and are located generally adjacent to the ink outlet 18 towards the second side portion 47 of the extension 44. This configuration of the chip 20 results in the electrical contacts being positioned generally adjacent to the ink outlet 18. The contacts 100 are spaced apart a distance D from the ink outlet 18 a distance less than a total width W_{T} of the cartridge assembly 10, wherein the width of the cartridge assembly 10 is measured between the rear wall 32 and cover 14 (see FIG. 7). In other arrangements, the chip 20 is configured with a reduced width W1 wherein the electrical contacts 100 are spaced from the ink outlet 18 a distance greater than width W_{T}.

The handles 22, 24 each include a top portion 110, a bottom portion 112, and a pliable portion 114 along a length of the handles 22, 24 between the top and bottom portions 110, 112. The top and bottom portions 110, 112 are operably mounted to the housing 112. The handles 22, 24 extend generally outward from the first and second side walls 34, 36, respectively of the housing 12.

Referring now to FIGS. 14 and 15, the pliable portion 114 of each of the handles 22, 24 is spaced apart from the side walls 34, 36 a distance X1 when the handles 22, 24 are in a rest state. A rest state is defined as a state in which a structure has no exterior forces applied thereto. FIG. 14 illustrates the cartridge assembly 10 being inserted into a cartridge bay 120. The cartridge bay defines a space sized to receive the cartridge assembly 10, wherein the space has a width W that is slightly greater than a width W_{C} of the cartridge assembly 10 measured between the outer the first and second sides 34, 36.

The width W is slightly less than a maximum W_{H} measured between the outermost portions of the handles 22, 24. As a result, when the cartridge assembly 10 is inserted into the printer carriage in the direction A shown in FIG. 14, the handles 22, 24 engage the cartridge bay 120. The handles 22, 24 comprise a structure and a material composition that permit compression of the pliable portion 114, thereby permitting the cartridge assembly 10 to be inserted into the position shown in FIG. 15 with an interference fit. The friction and other interference forces generated between the handles 22, 24 and the cartridge bay 120 when inserting the cartridge assembly 10 in the direction A help maintain the cartridge assembly 10 in a desired engaged position within the cartridge bay 120. The handles 22, 24 further provide this desired engaged position of the cartridge assembly shown in FIG. 15 without the use of latches, protrusions, keying features, or other mechanisms or structures that may otherwise be required to maintain the cartridge assembly 10 in the desired engaged position in the cartridge bay 120. Because there is no positive lock engagement between the cartridge assembly 10 and the cartridge bay 120, the cartridge assembly 10 can be easily removed by the user by simply pulling upward in the direction B as shown in FIG. 15. The cartridge assembly 10 can be moved more easily in the direction B if the handles 22, 24 are compressed further inward toward the side walls 34, 36, respectively by the user while pulling in the direction B.

Surfaces of the handles 22, 24 can be at least partially covered with a friction generating device or structure such as grooves, small protrusions, or secondary materials with high friction properties to improve the interference fit.

In other arrangements, one or the other of the handles 22, 24 can be configured with the structure and material composition necessary to compress when the cartridge assembly 10 is moved in the direction A into the cartridge bay 120. Further, one or more flexible handle members 22, 24 can be used in combination with a positive locking arrangement such as a latch, protrusion, or keying structure.

### CONCLUSION

One aspect of the present disclosure relates to an ink cartridge that includes a housing, an extension member, an electronic chip, and an ink outlet. The housing includes a top end portion and a bottom end portion, and defines an ink reservoir. The extension member extends from the bottom end portion. The electronic chip is positioned on the extension member. The ink outlet is positioned at the bottom end portion of the housing and maintains ink flow communication with the ink reservoir. The ink cartridge can further include an air vent arrangement. A portion of the air vent arrangement extends from the top end portion of the housing to the bottom end portion of the housing to provide a source of air to the ink reservoir.

Another aspect of the present disclosure relates to a printer ink cartridge that includes a housing, an ink outlet, an air vent arrangement, and first and second handles. The housing includes at least a top wall, a bottom wall, and a plurality of side walls that define an ink reservoir. The ink outlet is positioned at the bottom wall. The air vent arrangement includes an air inlet to the ink reservoir that is positioned adjacent to the bottom wall. The first and second handles extend from opposing sides of the housing. The first and second handles each include a pliable portion, wherein the pliable portion is arranged spaced apart from the side walls of the housing from which the handles extend.

Another aspect of the present disclosure relates to a printer ink cartridge that includes a housing having a top wall, a bottom wall, and a plurality of side walls that define an ink reservoir containing ink, an ink outlet arrangement positioned on the bottom wall of the housing, an extension member extending from the housing in a direction away from the bottom wall, and an electronic chip positioned on the extension member. The printer ink cartridge can further include an air vent arrangement that includes a one-way valve positioned vertically below the bottom wall of the housing and in air flow communication with the ink reservoir. The printer ink cartridge can also include first and second handles that extend from opposing side walls of the housing.

A further aspect of the present disclosure relates to a method of mounting a printer ink cartridge in a printer cartridge bay. The printer ink cartridge includes a pair of handles extending from opposing side walls of the printer ink cartridge, wherein each handle is configured to move towards the side wall from which the handle extends. The handles are devoid of latching features. The method steps include engaging the handles with opposed side walls of the printer cartridge bay, and moving the handles toward the side walls of the printer ink cartridge while mounting the printer ink cartridge in the printer cartridge bay.

The above specification provides examples of how certain inventive aspects may be put into practice. It will be appreciated that the inventive aspects can be practiced in other ways than those specifically shown without departing from the spirit and scope of the inventive aspects.

We claim:

1. An ink cartridge, comprising:
a housing defining an ink reservoir, the housing having a top end portion and a bottom end portion;
an extension member extending from the bottom end portion;
an electronic chip positioned on the extension member; and
an ink outlet positioned at the bottom end portion of the housing, the ink outlet in ink flow communication with the ink reservoir.

2. The ink cartridge of claim 1, further comprising first and second handles extending from opposing sides of the housing.

3. The ink cartridge of claim 2, wherein the first and second handles each include a pliable portion, the pliable portion arranged spaced apart from the sides of the housing from which the handles extend when the handles are in a rest state.

4. The ink cartridge of claim 2, wherein the handles each include top and bottom ends that are each secured to the housing.

5. The ink cartridge of claim 1, further comprising an air valve assembly positioned at the bottom end portion of the housing, the air valve assembly including a one-way valve that permits air to flow through the valve into the ink reservoir when a pressure condition in the ink reservoir exceeds a threshold negative pressure condition

6. The ink cartridge of claim 5, wherein at least a portion of the valve is positioned vertically below a bottom wall of the housing.

7. The ink cartridge of claim 1, wherein the extension defines a bottom edge, and the chip is recessed from the bottom edge.

8. The ink cartridge of claim 1, further comprising an air vent arrangement, a portion of the air vent arrangement extending from the top end portion of the housing to the bottom end portion of the housing.

9. The ink cartridge of claim 8, wherein the air vent arrangement includes an air inlet to the ink reservoir, the air inlet positioned at the bottom end portion.

10. The ink cartridge of claim 1, wherein the extension is integral with the housing.

11. A printer ink cartridge, comprising:
a housing having at least a top wall, a bottom wall, and a plurality of side walls that define an ink reservoir;
an ink outlet positioned at the bottom wall;
an air vent arrangement having an air inlet to the ink reservoir positioned adjacent to the bottom wall; and
first and second handles extending from opposing sides of the housing, the first and second handles each include a pliable portion, the pliable portion arranged spaced apart from the side walls of the housing from which the handles extend.

12. The printer ink cartridge of claim 11, wherein the handles each include a upper portion and a lower portion, the upper and lower portions each secured to the side walls of the housing.

13. The printer ink cartridge of claim 11, wherein a maximum width of the printer ink cartridge measured between the first and second handles is greater than a maximum width of the housing measured between the side walls to which the first and second handles are secured.

14. The printer ink cartridge of claim 11, wherein the handles are integral with the housing.

15. A method of mounting a printer ink cartridge in a printer cartridge bay, the printer ink cartridge having a pair of handles extending from opposing side walls of the printer ink cartridge, each handle configured to move towards the side wall to from which the handle extends, the handles being devoid of latch features, the method comprising steps of:
engaging the handles with opposed side walls of the printer cartridge bay; and
moving the handles toward the side walls of the printer ink cartridge while mounting the printer ink cartridge in the printer cartridge bay.

16. The method of claim 15, wherein the handles are configured to exert a force in an outward direction relative to the sidewalls with the handles engage the opposed side walls of the printer cartridge bay.

17. A printer ink cartridge, comprising:
a housing having a top wall, a bottom wall, and a plurality of side walls that define an ink reservoir containing ink;
an ink outlet arrangement positioned on the bottom wall of the housing; and
an extension member extending from the housing in a direction away from the bottom wall; and
an electronic chip positioned on the extension member.

18. The printer ink cartridge of claim 17, further comprising an air vent arrangement, the air vent arrangement including a one-way diaphragm valve positioned vertically below the bottom wall of the housing and in air flow communication with the ink reservoir.

19. The printer ink cartridge of claim 17, further comprising at least one handle member, the handle member extending from one of the side walls of the housing, the handle being devoid of a latching feature and including a pliable portion that is spaced apart from the housing when in a rest state.

20. The printer ink cartridge of claim 17, further comprising first and second handles extending from opposing side walls of the housing, the first and second handles including a portion that is spaced apart from the housing when in a rest state, and movable toward the housing upon application of a force directed toward the housing side wall to which the handle is mounted.

21. The printer ink cartridge of claim 17, further comprising an air vent arrangement, the air vent arrangement including an air channel, a sidewall of the housing defining a portion of the air channel that extends between the top wall and bottom wall of the housing.
